(19) United States
(12) Patent Application Publication
(10) Pub. No.: US 2021/0185464 A1
(43) Pub. Date: Jun. 17, 2021

(54) METHOD OF MANUFACTURING AN ASSEMBLY FOR A HEARING DEVICE

(71) Applicant: Oticon A/S, Smørum (DK)

(72) Inventors: Lars Steen CHRISTENSEN, Smørum (DK); Kristoffer RUNGE, Smørum (DK); Jesper TROLLE, Smørum (DK)

(73) Assignee: Oticon A/S, Smørum (DK)

(21) Appl. No.: 17/122,748

(22) Filed: Dec. 15, 2020

(30) Foreign Application Priority Data
Dec. 16, 2019 (EP) 19216646.0

(51) Int. Cl. H04R 25/00

(52) U.S. Cl. CPC H04R 25/658; H04R 25/609; H04R 25/607; H04R 25/652

(57) ABSTRACT

The present disclosure relates to a method for manufacturing an assembly comprising an in-the-ear part of a hearing device, the method comprising forming a mold comprising a cavity configured to hold an output transducer and comprising an opening for receiving a cover part, forming the cover part, forming at least one connecting leg for connecting the mold with the cover part, wherein the cover part is configured to fit into the mold opening for closing at least part of the mold opening, wherein the mold, the leg and the cover part may be formed during one forming operation so that the mold, the leg and the cover part are manufactured as one piece, removing the at least one leg and fitting the cover part in the mold opening.

### FIELD OF THE INVENTION

The present disclosure relates to a method of manufacturing assembly comprising an in the ear part of a hearing device. Further, the present disclosure relates to an assembly for an in the ear part of a hearing aid. Further, the present disclosure relates to a method of manufacturing a hearing aid comprising in the ear part. In particular, the present disclosure relates to a method of manufacturing a behind the ear hearing aid (BTE) comprising the in the ear part.

### BACKGROUND

In the field of hearing aids, especially BTE hearing aids, an issue of visibility of the hearing aid is important. In particular, users want a hearing aid to be visible as little as possible. In order to achieve that, one measure is to provide an in the ear part of a hearing device where the color is adjusted to the skin color of the user. This could be achieved by an in the ear part of a hearing device to be provided in a customized color. However, a hearing aid need to be primarily suitable for hearing needs of the user. This means that the user needs a hearing device having specific gain for compensating a specific hearing loss of that user, which results in a requirement for a specific size of the speaker/output transducer and subsequent size of a cover adjusted to the speaker. However, in such a case producing a hearing aid with an in-the-ear part being customized for the specific user requires not only a specific color but also specific size of the cover with connectors for connecting with a behind-the-ear part of the hearing aid. This results in increasing costs. Thus, there is a need to provide a in the ear part with a cover made from the same material and shaped so that the cover fits to the in the ear part in high accuracy. Moreover, since the cover is intended for use with a specific, preferably shaped to match an ear canal of the specific user, it is important that during production the in the ear canal element and the specific cover are provided for assembly together.

Therefore, there is a need to provide a solution that addresses at least some of the above-mentioned problems.

### SUMMARY

According to an aspect of the present disclosure a method of manufacturing an assembly comprising an in-the-ear part for a hearing device is provided. The method may comprise forming a mold comprising a cavity configured to hold an output transducer, and comprising a mold opening for receiving a cover part. The method may comprise forming at least one connecting leg for connecting the mold with the cover part. The cover part may be configured to fit into the mold opening for closing at least part of the mold opening. The method may comprise forming the cover part. The mold, the leg and the cover part may be formed during one forming operation so that the mold, the leg and the cover part are manufactured as one piece.

Since the mold part and the cover are manufactured as one piece, the cover and the mold may be produced in a customized color chosen to best match the skin color of the intended user. This means that the assembly according to the disclosure may be printed in the same printing operation, which means at the same printer and in the same process. This means the same printing conditions may be provided when producing the individual parts, which results in improved color matching of the cover and the in the ear part element. The cover is preferably printed in the same orientation as the in the ear part for better accuracy related to a 3d printer. The least one leg provides that the mold and the cover are connected. Therefore, handling and cleaning of the 3d printed assembly is facilitated. Moreover, the cover is joined with the specific mold with which is intended to be used, which eliminates a risk of mismatching of the cover during assembling of hearing device. Thus, in production, advantageously a step of matching a cover with the in-the-ear part is eliminated.

The forming may be or include additive manufacturing process.

The forming method according to the disclosed method may be performed by additive manufacturing process, such as a 3d printing method. One official industry standard term (ASTM F2792) is often used for applications of the technology. The additive manufacturing process is a process of joining materials to make objects from 3D model data, usually layer upon layer, as opposed to subtractive manufacturing methodologies. The additive manufacturing methods includes Digital Light Processing (DLP), Stereolithography Apparatus (SLA), Selective Laser Sintering (SLS), Fused Deposition Modeling (FDM), MultiJet Modeling (MJM). Advantageously, the method according to the disclosure may be Digital Light Processing (DLP).

The method may comprise forming the at least one leg at a position so that the one leg keeps the cover part in a position substantially parallel to the opening.

When the cover is printed so that it is placed opposite an opening in the mold, after the assembly is printed, the cover just needs to be pressed out. Pressing the cover to the opening into a mold opening is possible since the legs are made so that can be easily broken and removed. The method may comprise forming four legs.

The method may comprise forming the four legs at corners of the cover part.

The method may comprise forming the mold and the cover part from the same material, preferably the material having the same color. Thus, the cover part and mold have the same color, preferably the color matched to a skin color of a user.

The method may comprise forming a recess for mounting an insert part having an inset part opening for receiving and mounting a connecting member, the connecting member configured for mechanically coupling the in the ear part to a behind the ear part of the hearing device.

According to an aspect of the disclosure an assembly comprising an in the ear part for a hearing aid is provided. The assembly may comprise a mold comprising a cavity configured to hold an output transducer and a mold opening for receiving a cover part. The assembly may comprise at least one connecting leg for connecting the mold with the cover part. The cover part may be configured to fit into the opening for closing at least part of the mold opening. The cover part, the mold, and the at least one connecting leg are formed as one piece.

According to an aspect of the disclosure a method of manufacturing a hearing aid comprising a in the ear part is provided. The method may comprise forming an assembly comprising an in-the-ear part of a hearing device. The in the ear part comprises a mold. The mold may have a cavity for holding an output transducer. The mold may have a mold opening. The assembly may comprise a cover part configured to fit into the opening for closing at least part of the opening, and at least one leg for connecting the in the mold the cover part. The assembly may be formed as one piece. The method may comprise removing the at least one leg. The method may comprise fitting the cover part in the mold opening.

The forming may be additive manufacturing process. Forming by additive manufacturing is especially advantageous for in the ear part which are customized in shape and color.

The at least one leg may be removed by breaking off. Breaking off is simple and easy to perform.

The at least one leg may be removed by cutting. Removing by cutting a may result in less marks remaining after removing the leg.

The hearing aid may be behind the ear hearing aid. Using the assembly formed as one piece is especially advantageous for behind the ear hearing aid, since in the ear part is matched to skin color of the user, therefore the in the ear part is less visible.

The cover part may comprise a recess for receiving an insert having an inset part opening for receiving and mounting a connecting member, the connecting member configured for mechanically coupling the in the ear part to a behind the ear part of the hearing device and the method comprises inserting the insert part to the cover part.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a hearing aid with a closing assembly according to the disclosure,

FIG. 2 shows a 3D printed assembly according to the disclosure,

FIG. 3 shows a 3D printed assembly w in an insert part according to the disclosure,

FIG. 4 shows a closing assembly with connecting member in different sizes,

FIG. 5 illustrates a method of manufacturing an assembly comprising an in-the-ear part of a hearing device;

FIG. 6 illustrates a method of manufacturing a hearing aid comprising a in-the-ear part.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A hearing device (or hearing instrument, hearing assistance device) may be or include a hearing aid that is adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears. ‘Improving or augmenting the hearing capability of a user’ may include compensating for an individual user's specific hearing loss. The “hearing device” may further refer to a device such as a hearable, an earphone or a headset adapted to receive an audio signal electronically, possibly modifying the audio signal and providing the possibly modified audio signals as an audible signal to at least one of the user's ears. Such audible signals may be provided in the form of an acoustic signal radiated into the user's outer ear, or an acoustic signal transferred as mechanical vibrations to the user's inner ears through bone structure of the user's head and/or through parts of the middle ear of the user or electric signals transferred directly or indirectly to the cochlear nerve and/or to the auditory cortex of the user.

The hearing device is adapted to be worn in any known way. This may include i) arranging a unit of the hearing device behind the ear with a tube leading air-borne acoustic signals into the ear canal or with a receiver/loudspeaker arranged close to or in the ear canal and connected by conductive wires (or wirelessly) to the unit behind the ear, such as in a Behind-the-Ear type hearing aid, and/or ii) arranging the hearing device entirely or partly in the pinna and/or in the ear canal of the user such as in an In-the-Ear type hearing aid or In-the-Canal/Completely-in-Canal type hearing aid, or iii) arranging a unit of the hearing device attached to a fixture implanted into the skull bone such as in a Bone Anchored Hearing Aid or a Cochlear Implant, or iv) arranging a unit of the hearing device as an entirely or partly implanted unit such as in a Bone Anchored Hearing Aid or a Cochlear Implant.

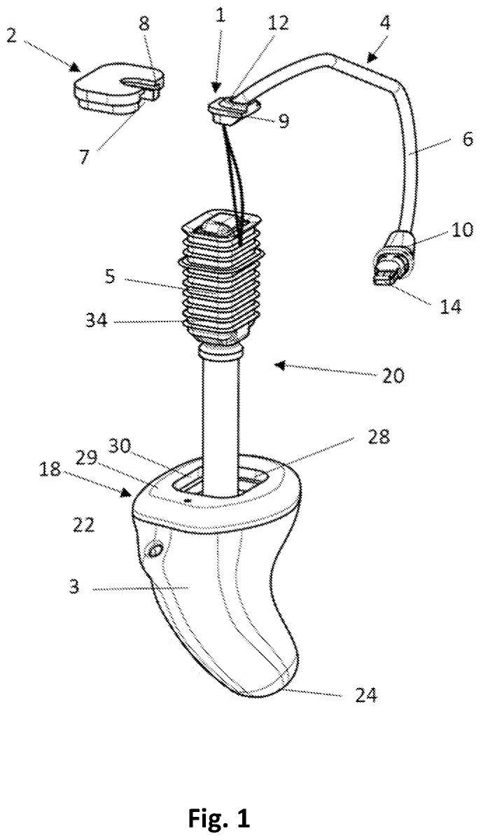

FIG. 1 illustrates an exploded view of an in-the-ear part, generally denoted 18, connected to a connecting member 4, having a plug or connector 14. The in the ear part 18 comprises a mold 3 shaped for intended user's ear canal. These general components are often referred to as a speaker assembly 20 for a hearing aid. FIG. 1 further shows a closing assembly according to the disclosure in an exploded view.

The closing assembly comprises an insert or inset part 1 and a cover or cover part 2. The cover part 2 comprises a recess 7. The recess 7 has a form of a cut made in at the outer edge or rim of the cover part 2. The cover part 2 may have a cavity or groove 8 formed along at least part of the recess 7. The insert part 1 may have a protrusion 9 arranged along at least part of a circumference of the insert part 1. The protrusion 9 is configured so that when the insert part 1 is inserted in the cutout or recess 7, the shape of the protrusion 9 corresponds to the shape of the cavity 8. Therefore, the insert part 1 suits or mates with the recess 7. In use, a connecting member 4 is provided, the connecting member 4 is configured to establish a mechanical connection between an in-the-ear part and a behind-the-ear part of a hearing aid. The insert part 1 is configured to be mounted onto an end of the connecting member 4. The insert part 1 with the connecting member 4 in then is fitted into a cover part 2. The insert part 1 has a top part 12 which complements the surface of the cover part 2 when the insert part 1 is placed in the cover part 2. When the insert part 1 is mounted to the cover part 2, the top part 12 is flush with the surface of the cover so that there is no visible transition between the two parts. Further, the top part, seen from above, has a very small size and as such does not contribute to the outer surface of the assembly to be noticeable. The top part 12 may be seen from the outside of the closing assembly. The top part 12 needs to be as narrow as possible in order to reduce visibility of the insert part 1 from the outside.

The connecting member 4 has, at the end opposite the end connected to the insert part 1, a tab-connector 14, configured to mate with a corresponding plug in a behind-the-ear housing of a hearing aid, not illustrated here. The connecting member 4 includes a number of electrical conductors configured to carry signals to and/or between the in-the-ear part and the behind-the-ear part. Such signals include signals for an output transducer 5, here an acoustic transducer referred to as a receiver, to convert in to sound signals to be outputted into the user's ear canal.

An end 11 of the connecting member 4 is mounted to the insert part 1 in an opening 26. The end 11 of the connecting member 4 is fixed in the opening 26. The connecting member 4 is preferably fixedly mounted in the opening 26. The mounting is performed for example by mechanical coupling and/or gluing. As there may be a smaller opening between the end 11 of the connecting member 4 and the insert part 1, a further material may be added to seal the opening so as to protect the interior of the in-the-ear part from e.g. cerumen and/or sweat or other contaminates.

The connecting member 4 comprises two electrically conductive wires for establishing communication from a sound processor in the behind-the-ear part and the output transducer in the in-the-ear part. If the in-the-ear part comprises additional components, such as input transducer, e.g. a so-called ear canal or monitor microphone additional wires may be provided to establish communication between these additional components and the behind-the-ear part. One end 11 of the connecting member 4 is fixed to the insert part 1 and at the other end of the connecting member 4 a connector 10 is attached. The connector 10 is for connecting with behind the ear part of the hearing aid (not shown). The output transducer 5 is provided with a suspension 34 to reduce vibrations to the custom part 3.

In the connecting member 4, a wire or conductor is received. This wire is used for establishing electrical connection between the output transducer 5 and the behind-the-ear part, where components such as microphones and signal processors are located.

Below the cover part 2, two wires 27 connect to the receiver 5. As the connecting member 4 is fixed relative to the insert part 1, the wire or wires 27 will not move when the user extracts or inserts the in-the-ear part from or into the ear canal. As a result, there is little or no risk of detaching the receiver/output transducer 5 from the electrical connection.

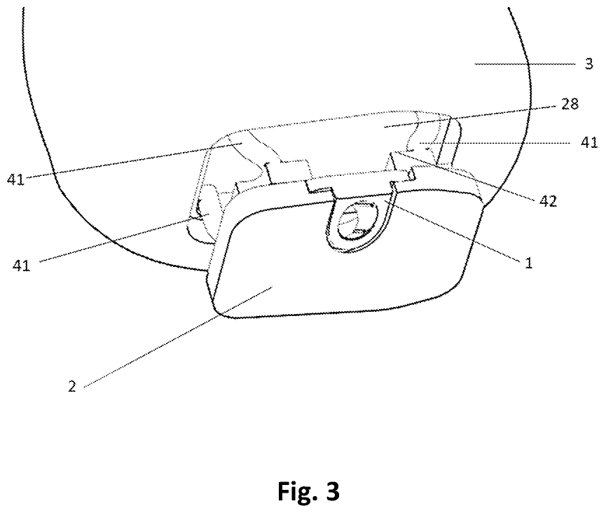

In FIG. 3 the insert part 1 is in position in the recess 7 of the cover part 1. The insert part 1 is provided with a protrusion 9, which engage the cavity 8 formed along the rim of the recess 7. The insert part 1 may thus be produced in just a single color, thereby making production simpler. As will be explained, the cover and the mold are produced by additive manufacturing and the material chosen may have a color as close a match as possible to the skin tone of the user.

The in-the-ear part shown in FIG. 1 further comprises a receiver 5 arranged or stored in a mold 3. The mold 3 is preferably a custom mold shaped to match an ear canal of the specific user. The cover part 2 and insert part 1 assembly is mounted in an outer face part 28 of the mold 3. The mold 3, outer face part 28 and the cover part 2 are manufactured in the same color, e.g. using the same material. This further allows choosing a color that best match the skin tone of that user for the majority of the parts that are visible during use of the in-the-ear part. During assembly, the insert part 1 is inserted to the cover part 2, and the cover part 2 closes or seals the mold 3 after the received 5 is placed in the mold 3. At the tip 24 of the mold 3, an outlet provides acoustic sounds from the receiver 4 to the ear canal of the user when the in-the-ear part is mounted/worn by the user. The insert part 1 will lie at or bear against a wall 30 of the in-the-ear part, and the cover part 2 will fit into the remainder of the opening 28.

The in-the-ear part, i.e. the mold 3, further comprises a vent canal 22. This canal ensures or at least alleviates pressure built-up in the ear canal when the mold 3 is inserted into the ear canal of the user. Further, when removing the mold 3 from the ear canal, the vent canal helps prevent or at least alleviates the potentially uncomfortable feeling.

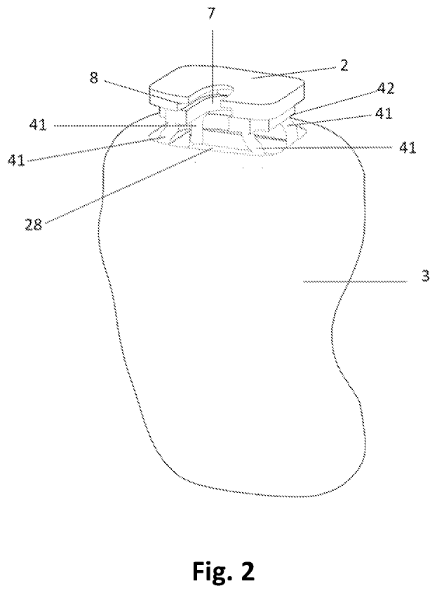

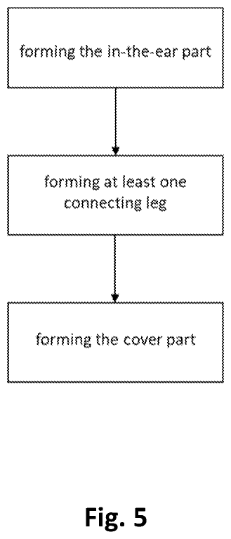

The method of manufacturing an assembly comprising an in-the-ear part for a hearing device according to the disclosure comprises forming the mold 3, the cover part 2 and the connecting leg 41 during one forming operation. The forming is realized preferably by additive manufacturing (also called 3d printing). In the method according to the disclosure, the assembly comprises forming a mold 3 comprising a cavity configured to hold an output transducer and a mold opening 28 for receiving a cover part 2. The method comprises forming at least one leg 41 and forming a cover part 2. The method is schematically illustrated in FIG. 5. The method may be performed in different order, namely the cover 2 may be formed first. The cover 2 with the mold 3 and the at least on leg 41 which connects the cover part 2 with the mold 3 are formed as one piece, as shown in detail in FIG. 2 and FIG. 3. In FIG. 2 and FIG. 3 the cover part 2 is connected with the mold 3 via four legs 41. In the method of manufacturing the assembly the legs 41 are arranged at corners of the cover part 2. The legs 41 are connected to a bottom part 42 of the cover part 2 at one end. The other end of the leg 41 may be connected to inside wall 30 of in the ear part opening 28. The legs 41 are preferably inclined towards interior of the in the rea part opening 28, which facilitates removing the legs 41. The legs 41 may have curved shape. The legs 41 may have variable cross section. In particular, the legs need so be shaped so that may be easily broken off.

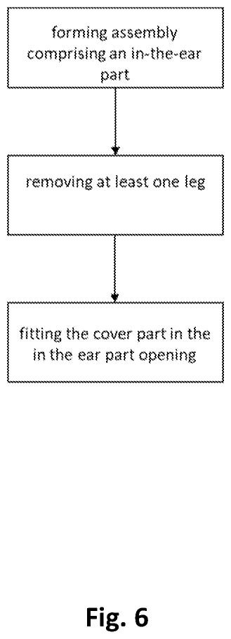

The assembly according to the disclosure is used for manufacturing a hearing aid. In the method of manufacturing hearing aid is schematically shown in FIG. 6. In the method according to the disclosure, the mold 3 and the cover 2 are connected by the legs 41 and are formed as one piece.

In order to fit the cover 2 into the mold opening 28, the legs 41 are broken off, preferably by pushing the cover 2 towards the mold opening 28. When the legs 41 are broken off, the cover is placed in the mold opening 28 thus closing, and in finished hearing aid sealing, the mold opening 28. The cover 2 preferably comprises a recess 7 for mounting an insert part 1, as described in detail in FIG. 3. The insert part 1 may be placed in the recess 7 before breaking of the legs 41.

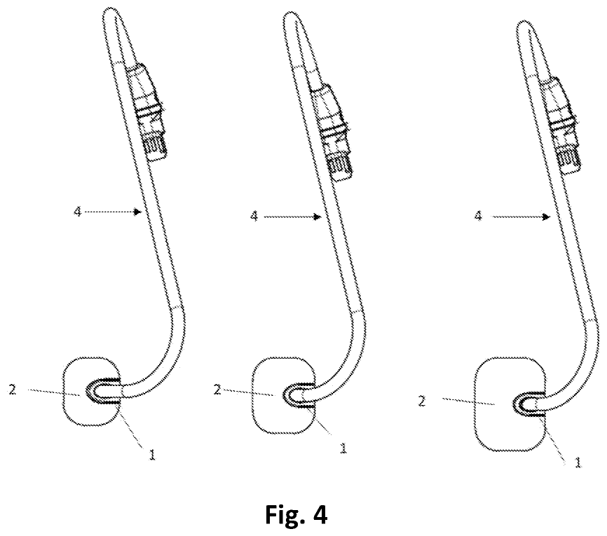

FIG. 4 illustrates three differently sized covers 1 each configured to close an opening in an in-the-ear part for receiving a correspondingly sized receiver. As mentioned, a larger receiver/output transducer is required for a higher sound output level. The closing assembly according to the disclosure is thus a universal part which may be used with different sized covers as shown in detail in FIG. 4. FIG. 4 shows the closing assembly according to the disclosure with covers of different size.

### LIST OF REFERENCE

1 insert part
2 cover part
3 mold
4 connecting member
5 output transducer or receiver
6 elongated part
7 recess or cutout
8 cavity or groove
9 protrusion
10 connector
11 end of elongated part
12 top part
14 tab connector
18 in-the-ear part
20 speaker assembly
22 vent canal
24 tip
25 glue
26 opening of insert part/biased opening
27 wire
28 mold opening
29 conductor
30 wall of in-the-ear part opening
34 suspension
36, 38 round corner
40 protrusion
41 leg
42 bottom part of the cover part 2

1. A method of manufacturing an assembly comprising an in-the-ear part for a hearing device, the method comprising:
forming a mold comprising a cavity configured to hold an output transducer, and comprising a mold opening for receiving a cover part,
forming the cover part,
forming at least one connecting leg for connecting the mold with the cover part,
wherein the cover part is configured to fit into the mold opening for closing at least part of the mold opening,
wherein the mold, the leg and the cover part are formed during one forming operation so that the mold, the leg and the cover part are manufactured as one piece,
removing the at least one leg,
fitting the cover part in the mold opening.

2. The method according to claim 1, wherein the forming is an additive manufacturing process.

3. The method according to claim 1, comprising forming the at least one leg at a position so that the at least one leg keeps the cover part in a position substantially parallel to the opening.

4. The method according to claim 1, comprising forming four legs.

5. The method to according to claim 4, comprising forming the four legs at corners of the cover part.

6. The method according to claim 1, comprising forming the mold part and the cover part from the same material.

7. The method according to claim 1, comprising forming a recess on the cover part for mounting an insert part having an inset part opening for receiving and mounting a connecting member, the connecting member configured for mechanically coupling the in the ear part to a behind the ear part of the hearing device.

8. An assembly comprising an in the ear part for a hearing aid comprising:
a mold comprising a cavity configured to hold an output transducer, and comprising a mold opening for receiving a cover part,
at least one connecting leg for connecting the mold with the cover part, the cover part is configured to fit into the opening for closing at least part of the mold opening, wherein the cover part, the mold, and the at least one connecting leg are formed as one piece.

9. A method of manufacturing a hearing aid comprising an in-the-ear part, the method comprising:
forming an assembly comprising a mold, the mold having a cavity for holding an output transducer, the mold having a mold opening, the assembly comprises a cover part configured to fit into the mold opening for closing at least part of the opening, and at least one leg for connecting the mold and the cover part, wherein the assembly is formed as one piece,
removing the at least one leg,
fitting the cover part in the mold opening.

10. The method according to claim 9, wherein the forming is an additive manufacturing process.

11. The method for manufacturing a hearing aid according to claim 9, wherein the at least one leg is removed by breaking off.

12. The method for manufacturing a hearing aid according to claim 9, wherein the at least one leg is removed by cutting.

13. The method for manufacturing a hearing aid according to claim 9, wherein the hearing aid is behind the ear hearing aid.

14. The method for manufacturing a hearing aid according to claim 9, wherein
the cover part comprises a recess for receiving an insert having an inset part opening for receiving and mounting a connecting member, the connecting member configured for mechanically coupling the in the ear part to a behind the ear part of the hearing device and the method comprises inserting the insert part to the cover part.

15. The method according to claim 2, comprising forming the at least one leg at a position so that the at least one leg keeps the cover part in a position substantially parallel to the opening.

16. The method according to claim 2, comprising forming four legs.

17. The method according to claim 3, comprising forming four legs.

18. The method according to claim 2, comprising forming the mold part and the cover part from the same material.

19. The method according to claim 3, comprising forming the mold part and the cover part from the same material.

20. The method according to claim 4, comprising forming the mold part and the cover part from the same material.
